(19) United States
(12) Patent Application Publication
(10) Pub. No.: US 2026/0307798 A1
(43) Pub. Date: Oct. 8, 2026

(54) AIRCRAFT SEAT UNIT AND AIRCRAFT CABIN LAYOUT

(71) Applicant: Safran Seats GB Limited, Cwmbran (GB)

(72) Inventor: James Byron Woodington, Cwmbran (GB)

(21) Appl. No.: 19/482,175

(22) PCT Filed: May 8, 2024
(86) PCT No.: PCT/GB2024/051198

§ 371 Date: Nov. 6, 2025

(30) Foreign Application Priority Data
May 19, 2023 (GB) 2307517.9

(51) Int. Cl. B64D 11/06

(52) U.S. Cl. CPC B64D 11/0601; B64D 11/0606; B64D 11/0644; B64D 11/0646

(57) ABSTRACT

An aircraft seat unit comprising a seat pan and an arm rest, wherein the arm rest is moveable from a first position, in which the arm rest is suitable for supporting the arm of a passenger sitting in the seat unit, and a second position, in which the arm rest is approximately co-planar with the seat pan, such that a further seating surface is provided.

### FIELD OF THE INVENTION

The present invention concerns an aircraft seat unit, and an aircraft cabin layout.

### BACKGROUND OF THE INVENTION

Developments in first class and business class aircraft seating arrangements have resulted in aircraft seat units that typically provide lie-flat seats enabling a passenger to move between a sitting position and a lying position depending on their preference.

The aircraft seat units also typically provide enhanced storage capacity for a passenger's personal items during flight, and/or work surfaces that allow the passenger to comfortably eat, read, and work using that surface.

The pace of development has not been as fast in aircraft premium economy seating arrangements, which is looking less attractive compared to the newer first and business class seating arrangements.

The present invention seeks to mitigate the above-mentioned problems.

Alternatively or additionally, the present invention seeks to provide an improved aircraft seat unit and/or aircraft cabin layout in an aircraft premium economy class seating arrangement.

### SUMMARY OF THE INVENTION

The present invention provides, according to a first aspect, an aircraft seat unit comprising a seat pan and an arm rest. The arm rest may be moveable from a first position, in which the arm rest is suitable for supporting the arm of a passenger sitting in the aircraft seat unit, and a second position, in which the arm rest is approximately co-planar with the seat pan, such that a further seating surface is provided.

The aircraft seat unit may comprise shell. Particularly, a front side of the shell may provide a fixed backrest portion for a passenger sitting in the aircraft seat unit, and a rear side of the shell may provide a foot well portion for another aircraft seat unit.

The aircraft seat unit may comprise a console or storage cubby, which may be located above the foot well. Such console or storage cubby is configured for use by a passenger sat in the aircraft seat unit.

The aircraft seat unit may comprise a footrest, for example an ottoman.

The aircraft seat unit may comprise a central privacy screen and/or a side privacy screen.

According to a second aspect of the invention, there is provided an aircraft seat unit comprising a front shell and a rear shell. The front shell may comprise the footrest portion and/or the fixed backrest portion. In addition or alternatively, the rear shell may comprise the footrest portion and/or the fixed backrest portion.

According to a third aspect of the invention, there is provided an aircraft cabin, comprising a first row of at least one aircraft seat unit, particularly as here above described, specifically in a 1-2-1 configuration, and a second row of at least one aircraft seat unit, particularly as here above described, specifically in a 1-2-1 configuration., Each of the aircraft seat units is oriented at an angle of at least 45 degrees, particularly of at least 50 degrees, to a longitudinal axis of the aircraft cabin.

In addition or alternatively, a pitch between the aircraft seat unit of the first row and the aircraft seat unit of the second row is no more than 30 inches, particularly no more than 28 inches, specifically no more 26 inches or more specifically no more than 24 inches.

The orientation of an aircraft seat unit is understood to be the direction in which a passenger sitting in the aircraft seat unit is facing, when in a normal taxi/take-off/landing position, also designated by the acronym TTL.

Typically, this would be perpendicular to the plane in which the central section of a backrest of an aircraft seat unit is located in.

Where terms such as “front”, “rear”, and “side” are used, the skilled person will appreciate that an aircraft cabin has a front, a rear, and sides as determined by the front, the rear, and sides of an aircraft comprising that aircraft cabin.

The skilled person will appreciate that 30 inches may be converted to a metric measurement of approximately 76.2 cm, or 0.762 m. As it is common to express pitch measurements in inches in the aircraft industry, inches will continue to be used when providing various dimensions below.

The pitch may be measured in the direction of the longitudinal axis of the aircraft cabin. Advantageously, the aircraft cabin and seating arrangement within the aircraft cabin allows for the provision of many of the benefits of the developments to first and business class seating arrangements, but without requiring the extended pitch of those seating arrangements.

Therefore, the aircraft cabin may be used for premium aircraft seating arrangements, or possibly business class seating arrangements on shorter haul flights where the need to provide a lie-flat option is reduced.

The skilled person will appreciate a 1-2-1 seat configuration comprises a single aircraft seat unit being located adjacent a side of the aircraft cabin, an aisle, two central aircraft seat units, another aisle, and then a single aircraft seat unit being located adjacent the opposite side of the aircraft cabin.

The 1-2-1 configuration advantageously allows for direct aisle access for all passengers. Each of the aircraft seat units may be oriented towards an adjacent aisle. Each of the aircraft seat units may comprise a shell defining a rearmost portion of the seat. The shell may comprise a fixed backrest. The fixed backrest may comprise one or more cushions, for example contoured cushions, to improve the comfort of a passenger sitting in the aircraft seat unit.

The shell may comprise a contoured portion, sometimes known as a foot well, into which a passenger sitting in an aircraft seat unit behind the shell may insert their feet. The shell may surround a footrest such as an ottoman, on which a passenger may rest their feet.

A console may be located about the foot well, the console arranged to be to the side of a passenger sitting in the aircraft seat unit.

Such an arrangement allows two passengers to utilise the same space, separated vertically, in different ways, one passenger using the lower space to position their feet, and the other passenger using the upper space as a console.

Each of the aircraft seat units may comprise a seat pan. The seat pan may extend from a fixed backrest. The foot well may be located to the side of the seat pan.

Each of the aircraft seat units may comprise a arm rest. The arm rest may be located directly adjacent the seat pan. The moveable arm rest may be located to the side of the seat pan, away from the aisle via which a passenger may gain access to the aircraft seat unit.

The arm rest may be moveable between
a first position, in which the arm of a passenger may be supported by the arm rest, and
a second position, for example approximately co-planar with the seat pan, in which a further seating surface is provided.

The seat pan has a seating area on which a passenger may sit.

The further seating surface provided by the moveable arm rest may comprise a seating area of at least 30%, 40%, 50%, 60%, 70%, 80%, 90% or 100%, or more than 100% of the seating area of the seat pan.

The arm rest may comprise a seat pan extension.

Such an arrangement may provide a passenger with alternative sitting positions, or may allow for companion seating. The alternative seating position may comprise the passenger bringing their feet up onto the seat pan or moveable arm rest.

The backrest of the aircraft seat units may be contoured to provide additional support to a passenger in an alternative sitting position, for example, the backrest of the aircraft seat units may wrap-around the passenger to provide back support even if the passenger sits at a 90 degree angle to the TTL orientation.

The shell may comprise one or more moveable privacy screens. The moveable privacy screens may be moveable between
a closed position, in which a passenger is screened from other passengers and/or the aisle, and
an open position, where the passenger is not screened to the same extent. The open position may be required for example due to TTL requirements, and/or to allow a passenger to be served by an airline attendant.

The aircraft seat units located in the centre of the 1-2-1 seat configuration may share a shell. That shell may comprise two back rest portions and two foot rests.

The shared shell may comprise a moveable privacy screen, which may be moved up to screen the two passengers in the centre seats from one another, and may be moved down to allow the two passengers in the centre seats to see and easily communicate with one another.

It will of course be appreciated that features described in relation to one aspect of the present invention may be incorporated into other aspects of the present invention. For example, the first aspect of the invention may incorporate any of the features described with reference to the other aspects of the invention and vice versa.

### DESCRIPTION OF THE DRAWINGS

Embodiments of the present invention will now be described in detail, by way of non-limiting examples, but the present invention is not limited to these disclosures, and will make it easy to understand what the invention consists of and how it can be embodied, only with reference to the accompanying schematic drawings of which:

FIG. 1 shows a plan view of a layout of passenger accommodation according to a first embodiment of the invention;

FIG. 2 shows a front side view of an aircraft seat unit according to the invention; and

FIG. 3 shows a rear side view of an aircraft seat unit according to the invention;

FIGS. 4 and 5 show perspective views of aircraft seat units according to the invention in different configurations and with passengers sat in different orientations; and

FIG. 6 shows a perspective view of an aircraft seat unit according to the invention including moveable privacy screens.

### DETAILED DESCRIPTION

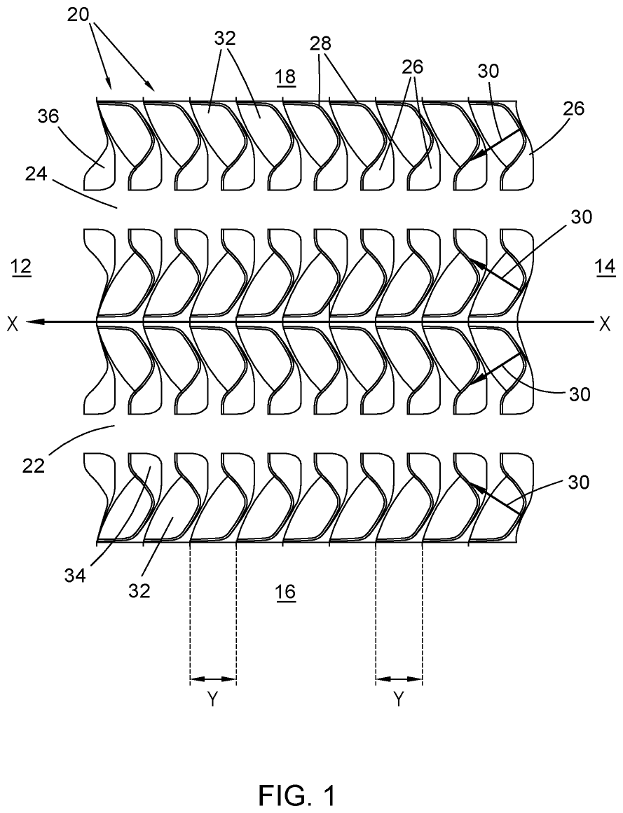

FIG. 1 shows a plan view of a layout of passenger accommodation, also designated by the acronym LOPA, of an aircraft cabin according to a first embodiment the invention. The aircraft cabin comprises a front 12, a rear 14, a left side 16, and a right side 18. An arrow X-X indicates the approximate central longitudinal axis of the aircraft cabin, and points in the line of flight direction.

A plurality of aircraft seat units 20 are provided in rows, particularly in a 1-2-1 configuration. A first aircraft seat unit is located at the left side 16 of the aircraft cabin, at least a second aircraft seat unit and/or a third aircraft seat unit is/are located in the middle of the aircraft cabin and a fourth aircraft seat unit is located at the right side 18 of the aircraft cabin.

In such arrangement, the aircraft cabin may comprise at least a first aisle 22 between the first aircraft seat unit and the second aircraft seat unit.

In addition, the aircraft cabin may comprise at least a second aisle 24 between the second aircraft seat unit or the third aircraft seat units is/are located in the middle of the aircraft cabin and a fourth aircraft seat unit.

In a particular specific arrangement, the aircraft cabin may comprise at least a third aisle between the second aircraft seat unit and the third aircraft seat unit.

Each of the aircraft seat units comprises a shell 26, which may comprise a backrest portion 28, particularly a fixed backrest portion 28. An orientation of the fixed backrest portion 28, particularly of the fixed backrest portion 28, is indicated by a arrows 30.

The backrest portion 28 comprises a cushioned surface configured to provide support and comfort to a passenger sitting in the aircraft seat unit 20.

Each aircraft seat unit 20 is oriented towards an aisle, allowing direct access to a passenger, without the need for other passengers to move out of the way to allow ingress and egress from the seat unit 20.

The backrest portion 28 is formed on a front side of the shell 26, and supports the back of a passenger sitting on a seat pan 32 of the seat unit 20.

The shell 26 may further comprise a rear side, with a foot well 34, which is contoured to allow a passenger sitting in the aircraft seat unit 20 behind to place their feet in the foot well 34. According to a particular arrangement, the foot well 34 may be laterally offset to the backrest portion 28.

In a particular embodiment, a front row of aircraft seat units 20 is located behind a bulkhead. The bulkhead may comprise a contoured shell defining a front foot well 36 into which a passenger sat in the aircraft seat units 20 of the front row may place their feet A pitch of the aircraft seat units 20 is measured as a distance, in the longitudinal direction X-X, between a point of one aircraft seat unit 20 and a corresponding like point of the aircraft seat unit 20 located in front. The pitch is indicated by the arrow Y in FIG. 1.

In the particular embodiment shown in FIG. 1, the pitch of the aircraft seat unit 20 is approximately 24 inches, such that nine rows of aircraft seat units 20, in a 1-2-1 configuration, provides accommodation for 36 passengers in an aircraft cabin length of approximately 231 inches.

In the particular embodiment shown in FIG. 1, each of the aircraft seat units 20 is oriented at approximately 50 degrees to the longitudinal axis X-X.

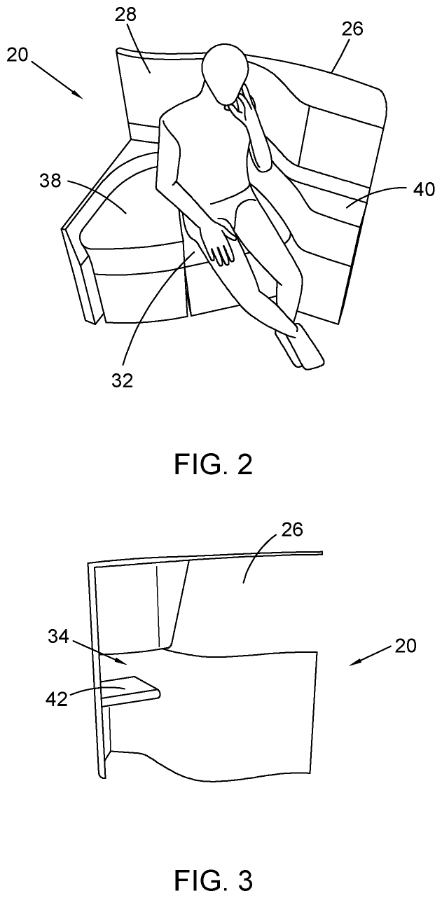

FIG. 2 shows a front side view of a schematic representation of the aircraft seat unit 20 according to the invention, with a passenger sitting on the aircraft seat unit 20. The seat unit 20 may further comprise an arm rest 38, particularly a moveable arm rest 38, located to the side of the seat pan 32, specifically away from the aisle. In the particular embodiment shown in FIG. 2, the arm rest 38 is shown in an arm supporting position.

In an alternative embodiment, the arm rest 38 may be located close the aisle.

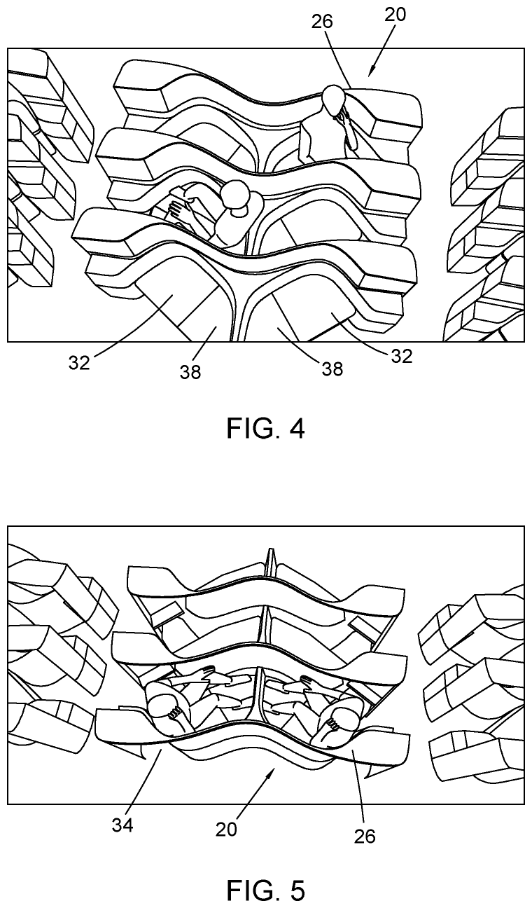

The arm rest 38 may be lowered from the arm supporting position into a position approximately coplanar with the seat pan 32, as shown in FIG. 4. This allows the arm rest 38 to act as an extension to the seat pan 32, and a passenger may decide to sit in an alternative orientation to when the arm rest 38 is in the arm supporting position.

Such an alternative orientation is shown in FIG. 4, with one passenger shown sitting in the usual, and TTL position, and another passenger sitting in the alternative orientation, in this case sitting on the arm rest 38, at approximately 90 degrees to the TTL position.

The space underneath the moveable arm rest 38 may include one or more cubbyholes providing storage for a passenger, and additional cubbyholes may be located around the passenger as required.

The shell 26 of the aircraft seat unit 20 comprises the foot well 34 for a passenger sat behind the aircraft seat unit 20 to locate their feet. As can be seen in FIG. 2, the foot well 34 extends to the side of a passenger sat in the aircraft seat unit 20.

The aircraft seat unit 20 may also comprise a console 40. The console 40 may be formed above the foot well 34, allowing additional storage options and/or a resting place for food, drink, passenger belongings and so on.

FIG. 3 shows a rear side of the aircraft seat unit 20, particularly of the shell 26, including the foot well 34. The shell 26 may include an ottoman shelf 42 that a passenger may decide to rest their feet on.

The rear side of the shell 26 may also house a monitor and/or other in-flight entertainment units, for the passenger sitting behind the aircraft seat unit 20.

The rear side of the shell 26 may also include a table which may be deployed by the passenger sitting behind the aircraft seat unit 20 for eating, drinking, reading and/or working.

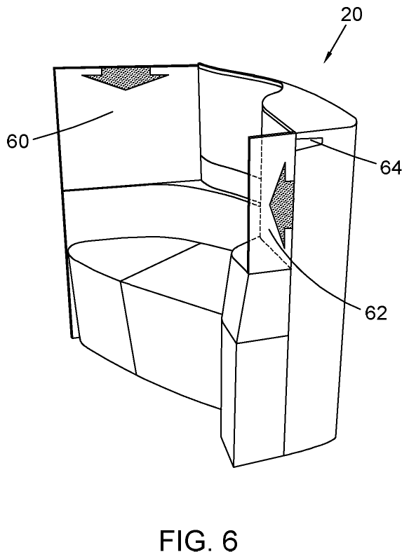

FIGS. 4 and 5 show perspective views of aircraft seat units 20 according to the invention in different configurations and with passengers sat in different orientations. Particularly, FIGS. 4 and 5 show possible ways in which central aircraft seat units may be configured and used.

In the particular embodiment shown in FIGS. 4 and 5, two aircraft seat units 20 may share a common shell 26, which provides two backrest portions 28, two foot wells 34, and so on.

FIG. 4 shows one passenger sitting in the TTL position and facing the aisle, and a second passenger in an alternative orientation, approximately 90 degrees to the TTL position.

FIG. 5 shows two passengers sat in two aircraft seat units 20, each passenger in another alternative seating orientation, such that they are facing towards one another with their feet resting on the arm rest 38.

The common shell 26 may comprise a central privacy screen 60, which may be lowered, such that the two passengers may easily see and communicate with one another.

FIG. 6 shows a perspective view of the aircraft seat unit 20 with the central privacy screen 60, which may be arranged on a side of the aircraft seat unit 20, which may be in a central position located between two joined aircraft seat units 20. In addition, the aircraft seat unit 20 may comprise a side privacy screen 62. Arrows indicate the ways in which the central privacy screen 60 and the side privacy screen 62 may be moved.

The aircraft seat unit 20 also comprises a seat number 64 on the outside of the shell 26, allowing easy identification of the aircraft seat unit position.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The skilled person will appreciate that the shell 26 of the aircraft seat unit 20 may be fully or partially upholstered with cushions, fabrics and/or other materials, to enhance comfort, safety and/or visual appeal of the aircraft seat units 20. The shell 26 of the aircraft seat unit 20 may also comprise a screen and/or other flight entertainment devices.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents.

It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An aircraft cabin comprising a first row of at least one aircraft seat unit, and a second row of at least one aircraft seat unit,
wherein each aircraft seat unit comprises a seat pan and an arm rest, wherein the arm rest is moveable from:
a first position, in which the arm rest is suitable for supporting the arm of a passenger sitting in the seat unit; and
a second position, in which the arm rest is approximately co-planar with the seat pan, such that a further seating surface is provided,
wherein the each of the aircraft seat units is oriented at an angle of at least 45 degrees, to a longitudinal axis of the aircraft cabin,
wherein a pitch between the aircraft seat unit of the first row and the aircraft seat unit of the second row is no more than 30 inches, and wherein the seat units comprise a shell, wherein a front side of the shell provides a fixed backrest portion for a passenger sitting in the seat unit, and a rear side of the shell provides a footrest portion for another aircraft seat unit.

2. (canceled)

3. An aircraft cabin as claimed in claim 1, wherein the seat units comprise a front shell and a rear shell, wherein:
the front shell comprises the footrest portion and/or the fixed backrest portion; and/or
the rear shell comprises the footrest portion and/or the fixed backrest portion.

4. An aircraft cabin as claimed in claim 1, wherein the shell surrounds a footrest, such as an ottoman, on which a passenger may rest their feet.

5. An aircraft cabin as claimed in claim 1, wherein the aircraft seat units comprise a console or storage cubby.

6. An aircraft cabin as claimed in claim 1, wherein the aircraft seat units comprise a central privacy screen and/or a side privacy screen.

7. An aircraft cabin as claimed in claim 1,
wherein a pitch between the aircraft seat unit of the first row and the aircraft seat unit of the second row is particularly no more than 28 inches, or specifically no more 26 inches or more specifically no more 24 inches.

8. An aircraft cabin as claimed in claim 7, wherein the aircraft seat unit is oriented towards an adjacent aisle.

9. An aircraft cabin as claimed in claim 7, wherein the aircraft seat unit comprises a shell defining a rearmost portion of the aircraft seat unit.

10. An aircraft cabin as claimed in claim 8, wherein the shell is common for two aircraft seat units of the first row and/or of the second row.

11. An aircraft seat unit comprising a seat pan and an arm rest, wherein the arm rest is moveable from:
a first position, in which the arm rest is suitable for supporting the arm of a passenger sitting in the seat unit; and
a second position, in which the arm rest is approximately co-planar with the seat pan, such that a further seating surface is provided,
wherein the aircraft seat unit is configured to be oriented in an aircraft cabin at an angle of at least 45 degrees, to a longitudinal axis of the aircraft cabin,
and
a pitch that is not more than 30 inches, wherein the seat unit comprise a shell, wherein a front side of the shell provides a fixed backrest portion for a passenger sitting in the seat unit, and a rear side of the shell provides a footrest portion for another aircraft seat unit.
